(19) United States
(12) Patent Application Publication
(10) Pub. No.: US 2016/0081356 A1
(43) Pub. Date: Mar. 24, 2016

(54) METHOD FOR THE PREPARATION OF AN ENZYME TABLET

(71) Applicant: DUPONT NUTRITION BIOSCIENCES APS, Copenhagen K. (DK)

(72) Inventor: Jens DAMGAARD, Rønde (DK)

(21) Appl. No.: 14/786,150

(22) PCT Filed: Apr. 30, 2014
(86) PCT No.: PCT/EP2014/058890

§ 371 Date: Oct. 21, 2015

(30) Foreign Application Priority Data
Apr. 30, 2013 (EP) 13165950.0

(51) Int. Cl. A21D 8/04; A23L 1/00; A23K 1/165

(52) U.S. Cl. CPC A21D 8/042; A23K 1/1653; A23L 1/0026; A23V 2002/00

(57) ABSTRACT

The present invention relates to a method for the preparation of an enzyme tablet comprising a high amount of enzyme (having a high pay-load) for use in for example the feed or food industry.

### FIELD OF THE INVENTION

The present invention relates to a method for the preparation of an enzyme tablet comprising a high amount of enzyme (having a high pay-load) for use in for example the feed or food industry such as tablets suitable for direct sale to bakeries.

### BACKGROUND OF THE INVENTION

Enzymes in tablet form have been used by bakers for many years in dough, the tablets enhancing the ability of the bread to maintain a soft, moist crumb for considerably longer than traditional anti-staling solutions. It is this softness that consumers perceive as freshness when choosing which bread to buy. At the same time, the enzymes secure a high degree of resilience, ensuring bread products stay attractively in shape on store shelves.

WO9500121 discloses a directly compressible enzyme powder produced by mixing a liquid enzyme preparation with a suitable carrier, using the principle of wet granulation, whereby the step of freeze-drying and spray-drying is avoided. WO07008776 discloses a single-dose enzyme tablet for direct sale to consumers for boosting the performance of automatic laundry and dish washing operations using conventional detergents.

However, traditional methods for producing enzyme tablets for use in for example bakeries are not always suitable due to the requirements that the tablet should at the same time be robust, able to self-disintegrate in water and at the same time contain a high amount of enzyme. This is especially difficult because enzymes are proteins, which act as binders making it difficult for an enzyme tablet with a high enzyme pay-load to self-disintegrate in for example water. There is thus a need for a method for preparing enzyme tablet(s) containing a high amount of enzyme (having a high pay-load) which ensure fewer tablets per batch of for example dough and less storage cost and storage space for the end user. There is also a need for high pay-load enzyme tablets in industries using liquid enzyme products. Using tablets which simply could disintegrate and produce the needed liquid enzyme product may minimise storage space, transportation costs and increase shelf life. Furthermore, there is also a need for a method for preparing enzyme tablet(s) which method result in tablets which are very robust i.e. have low friability for handling and transport and which at the same time are able to self-disintegrate in water preferably within 3 min.

### SUMMARY OF THE INVENTION

It has been found by the present inventor(s) that an enzyme tablet comprising a high amount of enzyme (a high pay-load) may be prepared by drying a slurry of the required enzyme(s) and an insoluble carrier to obtain an enzyme powder, optionally by further agglomerating of said enzyme powder, followed by direct compression of said powder or agglomerated powder. It has further been found that enzyme tablets produced by the herein disclosed method are very robust i.e. having a low friability for handling and transport and at the same time are able to self-disintegrate in water preferably within 3 min.

So, in a first aspect the present invention relates to a method for preparing an enzyme tablet by a method comprising the following steps:
a) mixing of an enzyme(s) and an insoluble carrier to obtain a slurry,
b) drying of said slurry to obtain a dried enzyme powder with particles having a volume mean diameter greater than 30 μm, and wherein the content of insoluble carrier in the dried enzyme powder is at least 10% (w/w) and at the most 50% (w/w) based on the weight of the dried enzyme powder, and
c) direct compression of said dried enzyme powder to obtain said tablet, wherein said tablet comprises at least 10% (w/w) of said enzyme.

### DETAILED DISCLOSURE OF THE INVENTION

Disclosed herein is a method for the preparation of an enzyme tablet, the method comprising the following steps:
a) mixing of an enzyme and an insoluble carrier to obtain a slurry,
b) drying of said slurry to obtain a dried enzyme powder with particles having a volume mean diameter greater than 30 μm, and wherein the content of insoluble carrier in the dried enzyme powder is at least 10% (w/w) and at the most 50% (w/w) based on the weight of the dried enzyme powder, and
c) direct compression of said dried enzyme powder to a tablet, wherein said tablet comprises at least 10% (w/w) of said enzyme.

In one aspect, said enzyme is added to obtain the slurry in the form of an enzyme solution.

In the present context, the term “an enzyme solution” is defined herein as a liquid enzyme solution comprising one or more enzymes which are distributed uniformly throughout the liquid.

In one aspect, the enzyme solution is able to be filtered on a traditional plate-and-frame filter press equipped with filter cloth and coated with filter aid in order to remove visible particles resulting in a clear filtrate with a turbidity of less than 10 NTU. In a further aspect, the enzyme solution may be filtered on a plate-and-frame filter press packed with filter pad coated with filter aid in a filtration that leads to germ reduction for example in order to meet food and/or feed quality requirements. If filtrations are used they should preferably be performed without losing substantial enzyme activity (preferably less than 10% loss) as measured by a suitable test for the enzyme(s) in question.

In the present context the term “dried enzyme powder” means that the dry matter of the powder is >90% (w/w) as measured according to the method “Dry matter determination test” described under “General Procedures”. In one aspect, the dry matter of the dried enzyme powder is >92% (w/w), >94% (w/w), or preferably >96% (w/w).

In one aspect, the particles of the dried enzyme powder have a volume mean diameter greater than 30 μm. In the present context, the particle size of a powder is measured as “volume mean diameter” (D[4,3]), such as described by Rawle, A.: “Basic principles of particle size analysis” in Surface Coating International 2003, vol. 86, n°2, pp. 58-65. Measurement of particle size in the work leading to this patent has been performed by laser diffraction (also known as Low Angle Laser Light Scattering, or LALLS) using a particle size analyser model Mastersizer S from company Malvern Ltd, UK.

In one aspect, the enzyme purity of the enzyme solution or enzyme slurry is in the interval of 50-100% (w/w) pure enzyme, such as 50-90% (w/w) pure enzyme. In the present context the term “enzyme purity” of an enzyme solution is defined as the dry matter of the enzyme in the solution or in the slurry (W_dry enzyme) divided by the dry matter content of the solution (W_dry solution). Hence it can be written as purity %=W_dry_enzyme/W_dry_solution; for instance a solution containing only the enzyme and no other substances has a purity of 100%.

The dry matter of the enzyme (W_dry enzyme) is determined by the enzyme activity of the sample (Unit/g sample) divided by the specific activity (Unit/mg enzyme). In the present context the term “enzyme activity” of a sample may be measured by a suitable test for the enzyme(s) in question. As an example of a test suitable for measuring enzyme activity of most amylases mention may be made of for example the herein described test in the examples under “General procedures” providing a result in Unit/g sample. The amylase test described herein under “General Procedures” is a protocol/test that measures the enzyme activity of G4 amylase, such as the G4 amylase used in the examples. This test is also a quality control test that can be used to standardize/quantify this enzyme for commercial sale. Other tests that are specific for the purpose of measuring enzyme activity of different enzymes will be known to the skilled person within the field. Typically such tests are a validated test that can be used for quality control. A test for measuring enzyme activity would typically also contain a substrate specific for the enzyme being measured and the reaction is controlled with the help of a buffer, pH, temperature and time. The reaction will be quantified against a standard enzyme of the same type. Using a substrate as described above secures that only active protein is measured hence this is common in the industry. In principle other protein quantification test could be used.

In the present context the term “specific activity” of an enzyme is defined as the enzyme activity per mass of the enzyme protein. It is defined as Unit per mg. For instance if a sample of G4 amylase is purified to contain 100% enzyme protein and the activity is determined by using the amylase activity test as described under “General procedures”, then the reported value in BMK per mg sample is per definition the specific activity. G4 amylase as used in the examples was for example determined to have a specific activity of 3.0 BMK/mg.

In the present context the term “total dry matter” of the enzyme solution is measured as described under “Dry matter determination test” under “General Procedures”.

In the present context, the term “tablet performance” of an enzyme tablet is used herein to describe the performance of a tablet or a batch of tablets with regard to one or more of useful tablet parameter(s). Examples of useful tablet parameters are friability, disintegration and/or self disintegration as measured in respectively a test for friability, disintegration and/or self disintegration for example as described herein under “General Procedures”. By a “good” tablet performance is herein meant the performance of tablets which perform within industry specification or as otherwise defined herein in one or all three tests. A tablet or tablet batch is considered herein to have an improved tablet performance if it shows improved results in at least one of the three tests, such as a decreased friability, a reduced disintegration or reduced self-disintegration time. In one aspect, making a tablet (or batch of tablets) with decreased friability is in this context thought of as providing an improved tablet performance if disintegration is not affected. For example a tablet recipe that results in a tablet or tablet batch with a self disintegration of 180 s and a friability of 4% (w/w) may be improved by optimizing tablet excipients, but keeping the same enzyme content compared to a tablet or tablet batch with a friability of 2% (w/w), but having the same self disintegration time of 180 s. This is for example understood herein as improved tablet performance.

Similar reasoning is possible to make for a reduced disintegration time, but keeping the parameter friability constant. A tablet or tablet batch may also be considered to have an improved tablet performance if friability is decreased and disintegration time is reduced at the same time. Optimization of a tablet recipe to improve one of the two parameters friability and disintegration at the expense of the other is more difficulty to define as an improvement, unless a very clear understanding of the application of the tablet is given. It is instead recommended to compare the tablet performance (for instance comparing different types and levels of excipients) by keeping either friability or disintegration (disintegration or self disintegration) constant and comparing the other parameter. In general this can be done by adjustment of the tablet machine by comparing tablets that have been produced applying different level of pressure from the pistons in the tablet machine. If the constant level (the target level) can not easily be obtained from the 2^{nd} of the two different tablet formulations, then two or more different pressures can be applied and a simple interpolation may be used to calculate at the target level.

### Enzyme

For use in the tablets as described herein, the enzyme may be any enzyme, e.g. one which may be used in the preparation of food and/or feed, a medicinal enzyme, an enzyme used as digestive aids, an enzyme useful for technical applications or any application where a precise and safe (such as non-dusting) dosage of an enzyme is needed or desirable. The tablets may comprise one or more enzymes.

The final tablet may comprise one or more enzymes. In one aspect, several enzymes are mixed together with an insoluble carrier to obtain a slurry, and the final slurry are thus comprising one or more enzymes. It is also possible to prepare several different slurries each slurry comprising one or more enzymes, and then mixing these slurries before drying. Another way of obtaining a tablet comprising several different enzymes is by preparing several enzyme powders and/or agglomerated powders and mixing these before direct compression.

The tablets herein are especially useful for enzyme applications, where a high pay-load of enzyme is desirable. In one aspect, the enzyme pay-load or amount of enzyme(s) in the tablet is at least 10% (w/w) enzyme. In a further aspect, the tablet comprises at least 10% (w/w) enzyme, such as at least 15% (w/w) enzyme, and at the most 45% (w/w) enzyme, such as at the most 40% (w/w) enzyme or at the most 20% (w/w) enzyme. In a further aspect, the tablet comprises between 10% (w/w) and 45% (w/w) enzyme, such as between 10% (w/w) and 40% (w/w) enzyme, such as between 15% (w/w) and 20% (w/w) enzyme.

In one aspect, the enzyme is a food enzyme such as a baking enzyme. In a further aspect, the enzyme is an enzyme used in brewing. In a further aspect, the enzyme is an enzyme used in dairy. In a further aspect, the enzyme is an enzyme used in oils and fats processing. In a further aspect, the enzyme is an enzyme used in meat processing.

In a further aspect, the enzyme is an enzyme used in feed for animals.

In one aspect, the feed material is selected from the group comprising a) cereals, such as small grains (e.g., wheat, barley, rye, oats and combinations thereof) and/or large grains such as maize or sorghum; b) by products from cereals, such as corn gluten meal, Distillers Dried Grain Solubles (DDGS) (particularly corn based Distillers Dried Grain Solubles (cDDGS), wheat bran, wheat middlings, wheat shorts, rice bran, rice hulls, oat hulls, palm kernel, and citrus pulp; c) protein obtained from sources such as soya, sunflower, peanut, lupin, peas, fava beans, cotton, canola, fish meal, dried plasma protein, meat and bone meal, potato protein, whey, copra, sesame; or d) oils and fats obtained from vegetable and animal sources.

In one aspect, the food material is selected from the group comprising dough for baking.

The enzyme for brewing may help optimal extraction of the natural raw material like wheat and barley. The enzyme may also help to improve throughput at the brewery. An enzyme for dairy may help to give the dairy product a better texture or flavour. It may extend the shelf life or be a processing enzyme that facilitates the production of UHT milk.

An enzyme for oil and fats may increase the extraction yield, lower the energy consumption or improve the quality of the oil.

An enzyme for meat processing may help increasing the protein yield, convert a by product into a more valuable product, enhance flavour or decrease bitterness of protein hydrolysates.

The enzyme may be chosen from amylases, lipolytic enzymes, oxidoreductases such as for example glucose oxidase and hexose oxidase, hydrolases, such as lipases and esterases as well as glycosidases like [alpha]-amylase, pullulanase, and xylanase.

Examples of other enzymes that may be included may be selected from the group consisting of a cellulase, a hemicellulase, a starch degrading enzyme, a protease, a lipoxygenase.

Examples of oxidoreductases include oxidases such as a glucose oxidase (EC 1.1.3.4), carbohydrate oxidase, glycerol oxidase, pyranose oxidase, galactose oxidase (EC 1.1.3.10), a maltose oxidising enzyme such as hexose oxidase (EC 1.1.3.5).

Other useful starch degrading enzymes which may be included are glucoamylases and pullulanases.

In one aspect, the term “xylanase” as used herein refers to xylanases (such as EC 3.2.1.32) which hydrolyse xylosid[iota]c linkages.

In one aspect, the term “amylase” as used herein refers to amylases such as [alpha]-amylases (EC 3.2.1.I), [beta]-amylases (EC 3.2.1.2) and [gamma]-amylases (EC 3.2.1.3.).

In one aspect, the enzyme is one or more selected from the group consisting of amylase, protease, pullulanase, isoamylase, cellulase, glucanase, xylanase, arabinofuranosidase, ferulic acid esterase, xylan acetyl esterase, phytase, oxidase, lipase and glucoamylase.

In one aspect, the enzyme is one or more selected from the group consisting of an amylase, a protease, a xylanase, an oxidase, and a lipase.

In one aspect, the enzyme is a phytase.

In one aspect, the enzyme is selected from the group of xylanases (EC 3.2.1.8), such as beta-1,4-D-xylanase, endo-1,4-beta-xylanase, endo-1,4-beta-xylanase, endo-(1,4)-beta-xylanase 4-xylanohydrolase, endo-1,4-xylanase, beta-1,4-xylanase, endo-1,4-beta-D-xylanase, 1,4-beta-xylan xylanohydrolase, beta-xylanase, beta-1,4-xylan xylanohydrolase, 4-beta-D-xylan xylanohydrolase, and beta-D-xylanase.

In one aspect, the enzyme is selected from the group of endo-1,3-beta-xylanase (EC 3.2.1.32), such as beta-1,3-xylanase, beta-1,3-D-xylanase, endo-1,3-xylanase, endo-1,3-beta-xylanase, endo-1,3-beta-D-xylanase, 1,3-beta-xylan xylanohydrolase, beta-1,3-xylan xylanohydrolase, endo-(1,3)-beta-xylan xylanohydrolase and 3-beta-D-xylan xylanohydrolase.

In one aspect, the enzyme is selected from the group of cellulases, in particular endo-1,4-β-glucanases (EC 3.2.1.4), Cellobiohydrolase (EC 3.2.1.176 and EC 3.2.1.91), endo-1,3-β-glucanases (3.2.1.6), hemicellulases, α-galactosidases (EC 3.2.1.22), polygalacturonases (EC 3.2.1.15), beta-glucosidases (E.C. 3.2.1.21), glucan 1,4-beta-glucosidase (EC 3.2.1.74) and cellulose-1,4-β-celloblosidase (EC 3.2.1.91).

In one aspect, the enzyme is selected from the group of endoglucanases, in particular endo-1,6-6-glucanases (EC 3.2.1.75), endo-1,2-β-glucanases (EC 3.2.1.71), endo-1,3-β-glucanases (EC 3.2.1.39), endo-1,4-beta-glucanases (EC 3.2.1.4), endo-1,3(4)-beta-glucanases (EC 3.2.1.6), and endo-1,3-α-glucanases (EC 3.2.1.59).

In one aspect, the enzyme is selected from the group of proteases, in particular subtilisins (E.C. 3.4.21.62), bacillolysins (E.C. 3.4.24.28), alkaline serine proteases (E.C. 3.4.21.x), keratinases (E.C. 3.4.x.x) and metalloproteases.

In one aspect, the enzyme is selected from the group of mannanases, in particular endo-beta-mannanases, esterases, exo-mannanases, and galactanases.

In one aspect, the enzyme is selected from the group of transferases, alpha-galactosidases, arabinosidases, aryl esterases, beta-galactosidases, catalases, cellobiohydrolases, cutinases, keratinases, laccases, lactases, ligninases, lipoxygenases, oxidases, pectate lyases, pectin acetyl esterases, pectinases, pentosanases, peroxidases, phenoloxidases, phosphatases, phospholipases, polygalacturonases, pullulanases, rhamnogalacturonases, tannases, transglutaminases, xylan acetyl-esterases, xyloglucanases, and xylosidases.

In one aspect, the enzyme is one or more amylases such as a maltotetraose-forming maltotetrahydrolase, also called EC 3.2.1.60; G4-forming amylase; G4-amylase or glucan 1,4-alpha-maltotetrahydrolase. In the present context, “G4 amylase” means a maltotetraose-forming maltotetrahydrolase (EC 3.2.1.60). Examples of such amylases are for example described in WO05/003339, WO04/111217, WO05/007867, WO05/007818, WO06/003461, WO07/007053, WO07/148224 and WO2010/133644. In one aspect, the amylase is a maltotetrahydrolase from Pseudomonas saccharophila. In a further aspect, the enzyme has SEQ ID NO: 1 or is a variant thereof. In one aspect, the variant has the amino acid sequence of SEQ ID NO: 1, wherein any number between one and 25 amino acids have been substituted. In a further aspect, the variant has the amino acid sequence of SEQ ID NO: 1, wherein any number between three and twelve amino acids has been substituted. In a further aspect, the enzyme has SEQ ID NO: 2 or is a variant thereof. In one aspect, the variant has the amino acid sequence of SEQ ID NO: 2, wherein any number between one and 25 amino acids have been substituted. In a further aspect, the variant has the amino acid sequence of SEQ ID NO: 2, wherein any number between three and twelve amino acids has been substituted.

The enzyme used to obtain said slurry may itself be in the form of an enzyme solution or an enzyme slurry or a blend of more enzyme solutions/slurries. An enzyme solution or slurry may be produced by removing the production strain from the fermentation broth, for example by filtration or centrifugation, where after the liquid is concentrated to the desired enzyme strength, for example by ultrafiltration or by evaporation. If an even higher purity is desired, the pH may be adjusted in order for the enzyme to precipitate to form a slurry where after the precipitate is separated from the supernatant. The pH may again be adjusted to bring the enzyme into solution. This enzyme solution will then usually have a higher purity than the initial enzyme solution. Depending on the required purity one or more steps of this process may be performed. In one aspect, the enzyme is added in the form of an enzyme solution. The purity may also be improved by salting out the enzyme by varying the pH or adding a chemical substance that leads to precipitation, like ammonium sulphate or acetone. Purification could also be done by chromatography like adsorption chromatography or affinity chromatography. Purification could also be done by diafiltration; which is a typical process used by enzyme manufactures wherein the concentration is performed by ultrafiltration by adding water to the process whereby smaller molecules can be washed out. The enzyme solution or slurry may be stabilized by addition of preservatives such as sorbate or benzoate and/or by addition of stabilizers such as polyols (e.g. propylene glycol), boric acid, salts, sugar (e.g. glucose and sucrose) or sugar alcohols (e.g. sorbitol) or carbohydrates of low molecular weight. The pH may be adjusted and stabilized, for instance with buffer salts such as salts of organic acids, e.g. sodium citrate and sodium lactate. Filtration that leads to germ reduction in order to meet food and/or feed quality is especially advantageous for an enzyme solution at neutral pH which may otherwise be difficult to preserve with food and/or feed grade preservatives to avoid microbial contamination. An enzyme solution with a lower pH may be preserved with typical food and/or feed grade preservatives such as sorbate and benzoate.

In order to obtain tablets with a high enzyme pay-load it is preferred to use an enzyme solution which has an enzyme purity in the interval of 50-100% (w/w) pure enzyme, such as in the interval of 60-100% (w/w) pure enzyme, such as in the interval of 65-100% (w/w) pure enzyme, such as in the interval of 70-100% (w/w) pure enzyme, such as in the interval of 75-100% (w/w) pure enzyme. In a further aspect, it is preferred to use an enzyme solution that has an enzyme purity in the interval of 50-100% (w/w) pure enzyme, such as in the interval of 60-95% (w/w) pure enzyme, such as in the interval of 65-90% (w/w) pure enzyme, such as in the interval of 70-90% (w/w) pure enzyme, such as in the interval of 75-90% (w/w) pure enzyme.

In one aspect, the enzyme solution as used herein may typically be clear measured as NTU<10 (NTU: nephelometric turbidity units). NTU of an enzyme solution may be measured on a HACH turbidimeter.

In one aspect, in order to obtain tablets with a high enzyme pay-load it is preferred to use an enzyme solution which has an enzyme purity of at least 65% (w/w) pure enzyme, such as at least 75% (w/w) pure enzyme.

Purity is defined as W_dry enzyme/W_dry solution. The dry matter content of the solution can be obtained as described under “General procedures” herein.

In another aspect, said enzyme solution has a dry matter content of 4-20% for example 5-20% w/w, such as 4-15% for example 5-15% (w/w) or 4-12% for example 6-12% (w/w).

In another aspect, said enzyme solution has a dry matter content of 5-20% w/w, such as 5-15% (w/w) or 6-12% (w/w).

In general it is substantially cheaper to remove water by membrane filtration (ultra filtration (UF)) instead of by drying. The difference is particular noticeable for dilute solutions (<20% (w/w) dry matter (in the following also DM)). The present invention is particularly advantageous to use for a high a number of enzymes solutions that can not be concentrated to a very high dry matter content because the enzymes will then have a tendency to fall out of solution. The present method may also be used with regard to an enzyme solution where the enzyme has partly felled out of solution to create a slurry; however it can be technically difficulty to continue further concentration to remove water, for instance in an ultra filtration unit, because the precipitate may start blocking the membrane(s). Further to the difficulties in concentration to a high DM level is also the issue of drying. The enzyme (dependent on the type) may give a lower recovery if it is dried as a slurry instead of in the form of a solution. These issues may lead to the conclusion that the pure enzyme is preferable dried as an enzyme solution (or slurry) with low DM. The invention disclosed may also work on lower DM levels like 2%, 3% or 4% (w/w), but for many commercial products the cost of drying becomes to high. For example a solution with 4% (w/w) DM would require evaporation of almost 24 kg of water to produce one kg of powder. At 5% (w/w) DM it is only 19 kg. It is therefore in general preferable to dry at a DM level as high as possible in the given situation. The invention disclosed herein is particular useful for enzyme solutions for which it is not possible to obtain a dry matter content of more than 20% (w/w), such as 15% or such as 12%.

The pH of the enzyme solution to be added depends on the enzyme(s). When the enzyme is an amylase such as a G4 amylase, the pH is typically in the range of 4-8, such as a pH from 5-7 or such as a pH of 5.5-6.5.

In one aspect, the enzyme is dissolved in a food and/or feed approved solvent such as water.

### Insoluble Carrier

In one aspect, an “insoluble” carrier is to be understood as a water insoluble carrier. In one aspect, less than 1% (w/w) of said insoluble carrier is soluble in water. In the aspect, where a small part of the carrier is soluble, the soluble part of the carrier in the enzyme solution or slurry will be included in the dry matter content of the enzyme slurry or solution. In one aspect, the dry matter content of the enzyme solution or slurry of 5-20% w/w, such as 5-15% (w/w) or 6-12% (w/w) as measured under “General procedures” herein.

In one aspect, the insoluble carrier is selected from the group of microcrystalline cellulose such as optionally coated with silica, polyvinylpyrrolidone (PVP), polyvinylpolypyrrolidone (PVPP), carboxymethylcellulose, alginate, clays, native starch, and modified starch, such as sodium starch glycolate or crosslinked starch. In one aspect, the insoluble carrier is selected from the group of polyvinylpolypyrrolidone (PVPP), microcrystalline cellulose, and wheat starch. In one aspect, the insoluble carrier is selected from the group of microcrystalline cellulose, and wheat starch. As examples of commercial products mention can be made of Avicel PH 101, Avicel PH 102, Avicel PH 200, Avicel PH 301, Vivapur 101, Vivapur 102, Vivapur 302.

In one aspect, the insoluble carrier is microcrystalline cellulose such as particulate microcrystalline cellulose. In one aspect, the volume mean diameter of the particulate microcrystalline cellulose is between 25-150 μm such as between 30-75 μm.

Particulate microcrystalline cellulose is a white free flowing powder. It is insoluble in water and resistant to most reagents. Microcrystalline cellulose is composed of glucose units connected by a 1-4 beta glycosidic bond. These linear cellulose chains are bundled together as microfibril. Each microfibril exhibits a high degree of three-dimensional internal bonding resulting in a crystalline structure. Typically the crystalline region is isolated and purified from wood pulp.

Wheat starch is a powder produced by removing the proteins, including gluten, from wheat flour. Wheat starch is a white, tasteless and odourless powder that is insoluble in cold water.

It consists of two types of molecules: the linear and helical amylose and the branched amylopectin.

### Slurry

In one aspect, the carrier in the dried enzyme powder is present in an amount of at least 10% (w/w) and at the most 50% (w/w) based on the weight of the dried enzyme powder. Example 13 shows that if no insoluble carrier is used the tablet L2 (with FNA protease enzyme) can not be produced with a good tablet performance. The same example shows N1 with a good tablet performance containing 12.5% enzyme. This is produced from a powder containing 18% (w/w) insoluble carrier. Example 8 shows that a tablet with G4 amylase powder can not be produced if the tablet is without carrier. Example 10 shows that the same G4 amylase enzyme solution can be made into a good performing tablet with 16% (w/w) enzyme. The powder used for this example was produced in example 3 and contains 22% (w/w) insoluble carrier.

The enzyme solution may be pumped into a tank with agitation. The process is typically performed at ambient temperature. The enzyme is typically stored at 5-10° C. so this process is typically run at 5-25° C. dependent on tank size, production time and ambient temperature. The tank can also be heated to the range 25-50° C. If a higher temperature is necessary to keep the enzymes in solution. The temperature range 25-50° C. may be a range that easily leads to microbially contamination so if the enzymes are stable it may also be a possibility to increase the temperature to the range 50-75° C. to have better microbial control. If an enzyme slurry with precipitated enzyme is used instead of an enzyme solution, pH and temperature adjustment in the tank can be done to bring the enzyme into solution before the carrier is added. The insoluble carrier may be added as a powder gradually to avoid too much lumping of the material. The tank may be constantly agitated to keep the carrier and the enzyme solution as a homogenous suspension and to avoid that the carrier sediments on the bottom of the tank.

### Drying

The suspension is usually pumped to the dryer. If an atomizer is used, the liquid suspension will then typically meet the atomizer. It could for example be a rotary atomizer or a pressure nozzle. In this case droplets are produced that meets the hot air in the dryer, and evaporation of water (or volatiles) from the droplets results in particle formation and drying of the particles.

Powder discharged from the bottom of the dryer can for example either be packed directly or it can be pneumatically conveyed through a sieve and then packed or blended with other powders and packed. The outlet air from the dryer may go through a cyclone to remove fines (very fine powder). The packed powders can be stored for a week, month or years or it can be sent directly to a tableting line were it is blended with other excipients before tableting.

In one aspect, the drying could be performed as a one stage spray drying or in a two-stage drying system where the spray drying step is followed by fluid bed or paddle/screw mixers as described in “Spray drying in practice” by Keith Masters, 2002, Published by SprayDryConsult International ApS, Krathusparken2, 2920 Charlottenlund (www.spraydryconsult.com). Spray drying followed by fluid bed such as in the GEA Niro VIBRO-FLUIDIZER™ may give the advantage of recirculation of fines to the spray dryer and thereby creating an agglomerate. In one aspect, the drying is performed as a freeze drying. Freeze drying for more heat sensitive enzymes is advantageous to avoid loss of active enzyme.

In one aspect, the particles of the dried enzyme powder have a volume mean diameter greater than 30 μm. In order to obtain particles of this size the skilled person may for example use spray drying.

In one aspect, the spray dryer may be operated in order to produce the biggest possible droplets that can still be dried before they reach the wall of the dryer. These droplets also results in the largest particle size, which again is optimal for tableting. For a spray dryer equipped with a rotary atomizer (for instance a spray wheel) the feed rate of enzyme solution (or slurry) and the speed of the wheel are controlled. As the skilled person will recognize, a lower speed leads to bigger droplets and hence bigger particles. Similar in a spray dryer where the atomizers are pressure nozzles the droplets can also be controlled by applying different pressures. The particle size is besides the size of the droplet also a consequence of the dry matter content (soluble and insoluble) in the slurry. As illustrated in example 2, traditional carriers, like salt and sugars, used to stabilize enzymes during drying does not provide the necessary particle size increase; even when used in an amount of more than 150 kg per 1000 kg of enzyme UF (ultrafiltration) concentrate. As shown in the present invention, using a small amount of an insoluble carrier helps the particle size formation during drying resulting in a high payload enzyme particle powder, which may be used for tabletting and further resulting in tablets having an improved tableting performance.

The above issue is particular an issue with the one stage spray drying (such as Niro Conventional Spray Dryer—SD) where the typical dryer design would limit the size of the droplets that technically can be produced. A tailor made dryer may be used delivering a longer travel distance. Typically a dryer with a rotary atomizer would be wider (bigger diameter of the tower) and hence bigger droplets and bigger particles can be produced. However, since enzymes are not heat stable the extended drying time (product residence time) will lead to loss of enzyme activity. This limits the size of the dryer design optimal for enzyme drying.

The present invention is also beneficial in a process, where the powder from step b is further agglomerated before step c (direct compression). The powder may be wetted with water in a fluid bed and agglomerated to larger particles. This has the advantage of keeping the same particle composition with respect to carrier content, however, optimizing the particle size for an improved tablet performance. It is shown in example 11 (table 6) that even further improvement on friability and disintegration can be obtained using agglomerated powder. A two step process where spray drying is used to produce a powder and the powder then is processed in a simple agglomeration process is a very cost efficient way of evaporation of liquid such as water to reach the high payload instead of having to use the fluid bed capacity to evaporate all the liquid from an enzyme solution with low dry matter content.

The two step process with a fluid bed following the spray drying may also provide a high efficiency of the spray dryer, if the powder that is discharge spray dryer still contain moist. The final drying is then in the fluid bed.

In one aspect, the drying is performed using a one stage spray dryer equipped with a rotary atomizer or pressure nozzles to produce liquid droplets into the dryer. Typical temperatures for spray drying may be in the range of 150-250° C. for the inlet temperature and 70-120° C. for the outlet temperature dependent on the design of the dryer. Outlet temperature should be chosen so that the powder has the desired level of humidity typical 5%, depending on the type of enzyme. Inlet temperature should also be chosen not to inactivate the enzyme although a higher temperature can lead to a higher energy efficiency of the dryer.

In one aspect, the enzyme particles of step b) have a volume mean diameter between 30-250 μm, such as between 30-150 μm, or such as between 35-75 μm or between 40-75 μm.

### Optional Agglomeration

In one aspect, the enzyme particles of step c) are further agglomerated before direct compression. The agglomeration process is herein defined as a process that makes individual particles adhere to each other. Agglomeration may be differentiated by granulation by being still able to observe the individual particles that went into the agglomerate, whereas granulation is creating a stronger more integrated particle where the individual particles can no longer be observed, although in some instances the two terms may be used somewhat interchangeable. Agglomeration and granulation is a way of controlling powder characteristics like flowability, dust release, density, particle size distribution. In the present context it is also a tool for improving tablet performance. In one aspect, the agglomeration is obtained in a single stage spray dryer where the fines for instance from the cyclone are returned into the atomizing zone and can adhere to droplets or wet particles.

In one aspect, the agglomeration is conducted on the already spray dried powder. This could be done in a fluid bed by simply spraying water into the powder bed or water plus a small amount of a binder for instance sugar.

In another aspect, the agglomeration may also be described as a granulation process. In one aspect, agglomeration is herein a granulation. One example is a wet granulation where the enzyme powder is continuously mixed and added a small amount of water or water with a binder like sugar. This can be done in a number of different mixer types for example in the Ploughshare® Food Mixer from Lödige. The mixer may also be used for drying the formed granulate to lower the water activity for a prolonged storage stability of the enzyme. The wet granulation has the advantage of delivering enzyme granulates that are ready for tableting without further processing. In another aspect, where the agglomeration may also be described as a granulation process is the process of using roller compaction followed by milling. This has the advantage of being high volume and a low cost process and no water or other liquid needs to be added, which is advantageous for heat sensitive materials like enzymes.

In one aspect, as disclosed herein agglomeration and granulation are tools to provide the right powder characteristics of the enzyme powder from b) in order to have a more optimal tablet performance (process c: compression).

In one aspect, the agglomerated enzyme particles have an average volume mean diameter between 40-1000 μm, or between 40-500 μm, or between 40-250 μm, or between 40-200 μm, such as between 50-150 μm.

### Direct Compression

The tablets described herein are made by direct compression of the dried enzyme powder which optionally has been further agglomerated, or added a part which has been further agglomerated.

In one aspect, the dried enzyme powder, which optionally has been further agglomerated or further agglomerated in part, is mixed thoroughly with one or more optional tablet excipients prior to entering the tablet machine. Excipients are blended in any suitable mixing device, such as a twin shell blender or similar apparatus, or using any mixing method that results in blending of the tablet excipients. The mixtures are then compressed into tablets, using any tableting device, such as an automatic rotary tablet press Kilian E 150, or a Stokes R4 single punch tablet press. Tablet presses generally have upper and lower shape-corresponding punches, which fit into a die from above and below the die. Mixed tablet material is filled into the die cavity and at least one of the punches, typically the upper punch, enters the die cavity. Pressure is applied to both the upper and lower punches. The action of the upper and lower punches moving toward each other, applies pressure to the material between the punches, thus forming a tablet.

A wide variety of tablet shapes can be made. Tablet shape is determined by the tooling of the punches. Compaction forces vary, depending on the punch geometry, type of instrument, and formulation used. Typical compaction forces can range from 0.2 kN to 22 kN.

### Tablets

The tablets described herein may be any shape, such as round or spherical, elongated, ellipsoid, cube-shaped, or other geometrical shapes. Tablets are herein understood to mean any solid enzyme formulation that is easily handled by the end-user, which includes, but is not limited to capsules, pills, gel-tablets, and dissolvable papers or sheets of dissolvable material. The size of the tablet may vary as well, and typically should be selected for ease of handling by the end-user. For example, in one embodiment the tablets are spherical balls having a diameter of about 18 mm. In general, diameters that make the tablets easy to handle are about 5 50 mm such as 15 mm to about 40 mm. In another embodiment the tablets are rectangular with at least rounded ends. The rectangular embodiment is about 25 mm in length, about 9 mm wide, and about 5-20 mm thick. In general, ellipsoid and rectangular tablets are easily handled where the length is from about 15 to 50 mm, the width is about 5 to 30 mm, and the thickness is about 3.5-20 mm. Sheet and cloth tablet embodiments may be thin and larger in length and/or width. In use, the end-user may remove the tablet from a packaging by hand and then drop it, for instance, into a glass beaker with water where it self-disintegrates and then the beaker content is poured into a food product such as a dough or a feed product, and the tablets should be sized to accommodate this expected use with ease. Packaging like a blister pack may facilitate ease of handling; especially the handling of small tablets like 0.5-1 g.

The weight of the tablets may be from about 0.4 g to 10 grams, 1 g to 10 grams, from 2 to 15 grams, from about 2 to 20 grams, from about 2 to 25 grams, and from about 2 to 30 grams. The density of the tablets maybe from about 0.5 to 1.7 g/cm³. In another aspect, the density is from about 0.6 to 1.4 g/cm³. In a more preferred aspect, the density of the tablets is from about 0.8 to about 1.2 g/cm³.

The tablets can be pan, or spray coated with a water soluble, film-forming material, such as polyethylene glycol (PEG 500), to reduce dust, and improve appearance. Those skilled in the art will recognize that the tablets can be coated with time-release materials. Additionally, tablets with more than one enzyme may coat the different enzyme components with coatings selected to release different enzymes at different times.

The tablets described herein are in general stable, however, packaging materials can be used to further extend the shelf life, protect against humidity in the environment, improve shipping durability, or enhance end-user convenience. The tablets described herein may be packed in buckets of 1 kg tablets and be packed with shock absorbing material to protect tablets during transport. The tablets may also be individually placed within a dissolvable packaging material, for example, polyvinyl alcohol film, that allows dissolving of the tablet directly without removal of packaging

The tablets may be covered in a shrink wrap process or they may be provided as blister packs, which are molded plastic sheets with backing material, for example a foil laminate, that allow the user to retrieve a tablet by pressing on it to release it from the packaging. The tablets may also be provided in sealed boxes, bottles or jars, any of which can be fitted with a dispenser feature. The outer packaging may include identification of the use of the tablet.

In the present context, having a “storage stability” of preferably a year means that if the tablet is stored in standard packaging at a temperature from 0-25° C., then enzyme activity measured after one year is above 90% of the measurement on day 0 (or within a week after production). Friability and disintegration values measured after a year should not have changed considerable or at least should be within the specification for the product at the time of production.

In one aspect, the loss of activity from step a) to after step b) is less than 20%. The loss of activity is defined as (A_tot_in−A_tot_out)/A_tot_in, where A_tot_in is the total enzyme unit coming from the liquid enzyme going in to the process and A_tot_out is the total unit of enzyme being measured in the dried powder.

Total unit is measured according to the QC method used for standardizing the commercial enzyme in question. For the G4 amylase described in example 2 the G4 amylase activity test found in section “General Procedures” is used.

For the FNA protease described in example 13 the FNA proteolytic activity test found in section “General Procedures” is used.

The friability of the tablets described herein should preferably be below 5% (w/w) measured as the weight % of the tablets which is broken of by rotating the tablets in a drum for 4 minutes with 25 RPM as described herein under “General procedures”. In one aspect, the friability is below 3% (w/w), such as below 2% (w/w) or below 1% (w/w).

A typical specification for tablets is a disintegration time of 180 s. This does not ensure a self-disintegration of the tablet as described under the “Self-disintegration test” found under “General procedures”.

The traditional disintegration test as described in the “General procedures” section is a widely accepted test used for pharmaceutical production. However, the test does not always correlate well with the customer's way of using the tablets within for example the food and/or feed industry. The customer would typically add the tablet to a beaker with water and leave it there to self-disintegrate, then return and add the content to for example the food and/or feed stuff e.g. a dough for baking. Traditional tablets that disintegrate in less than 180 s using the disintegration test described herein may typical use longer time to self-disintegrate. A tablet with a disintegration time of 180 s may even have a self-disintegration time of 600 s (10 min) or more.

The combination of for example silicified MCC as tablet ingredient disintegrant together with agglomerated enzyme in the form of a dried powder as described herein provides a tablet formulation that in general provides a much better correlation between disintegration and self-disintegration. Tablets according to the invention having a disintegration time of less than 100 seconds would typically self-disintegrate within 180 seconds.

The tablets as described herein should preferably disintegrate within 240 seconds, such as within 120 seconds. The disintegration time may be measured as described herein under “General procedures”. In one aspect, the disintegration time is within 180 seconds, such as within 100 seconds, such as within 90 seconds, such as within 80 seconds, such as within 70 seconds, such as within 60 seconds, such as within 50 seconds.

The tablets as described herein should preferably self-disintegrate within 300 seconds, such as preferably within 180 seconds. The self-disintegration time may be measured as described herein under “General procedures”. In one aspect, the self-disintegration time is within 180 seconds such as within 150 seconds, such as within 120 seconds, such as within 80 seconds, such as within 60 seconds, such as within 50 seconds.

### Other Tablet Excipients

In one aspect, the dried enzyme particles or dried agglomerated enzyme particles are mixed with further tablet excipients before step c).

In one aspect, the further tablet excipients are one or more selected from the group of binders, fillers, diluents, glidants, lubricants and disintegrants.

In one aspect, the tablets disclosed herein comprise a disintegrant.

Disintegrants are used to ensure that the tablet disintegrate to release the enzyme to perform its function. Any known disintegrant may be used, such as microcrystalline cellulose, polyvinylpyrrolidone (PVP), polyvinylpolypyrrolidone (PVPP), carboxymethylcellulose, alginate, clays, native starch, and modified starch, such as sodium starch glycolate or crosslinked starch. In one aspect, the disintegrant is an insoluble carrier. In one aspect, the disintegrant is the same as the insoluble carrier in step a). In one aspect, the disintegrant is particulate microcrystalline cellulose optionally coated with silica. In one aspect, the amount of disintegrant added as tablet excipient is between 20-80% (w/w), such as between 30-65% (w/w), such as between 40-60% (w/w) or between 50-60% (w/w).

To a large extent the enzyme powder in itself acts as binder and the need for a binder and/or filler is therefore in some tablets not necessary. However, in the case where a binder and/or filler is used it may be starch, for instance, modified starches such as wheat starch, corn starch, potato starch, any of which can be used in native form, pregelatinized form, or partially pregelatinized form. Other binders/fillers that are suitable for the present invention include dextrin, maltodextrin, sugars (such as lactose, fructose, dextrose, glucose, sucrose, raffinose, trehalose, and maltose), and sugar alcohols such as sorbitol, mannitol and inositol. In one aspect, the binder used is sorbitol. In one aspect, the binder is added to the tablet in an amount of 1-20% w/w, such as between 1-10% w/w, or between 1-5% (w/w).

Other binders/fillers suitable for use in the tablets are cellulose, microcrystalline cellulose, and modified cellulose materials such as hydroxypropylmethyl cellulose (HPMC), methyl cellulose, hydroxybutylmethyl cellulose, sodium carboxymethyl cellulose, hydroxyethylmethyl cellulose, hydroxy ethyl cellulose, acrylic polymers, latexes and polyvinyl pyrrolidone. Phosphates and sulfates also may serve as binders or fillers, for example dibasic calcium phosphate, monocalcium phosphate, or calcium sulfate dihydrate. A combination of two or more binders/fillers can be used in the tablets described herein. Additional binders/fillers include carrageenan, gum arabic, guar gum, xanthan gum, locust bean gum, chitosan, gelatin, collagen, casein, polyaspartic acid and polyglutamic acid, all of which can be efficient binders at low levels to minimize expense.

Lubricants and glidant agents that enhance tablet manufacture may be added to the tablet. Lubricants are added to tablet formulations in order to secure good lubrication of the pistons in the tablet machine, and to secure release of the tablet from the piston after compression. As used herein “lubricants and glidants” mean any agent, which reduces surface friction, lubricates the surface of the tablet, decreases static electricity or reduces friability of the tablets. Lubricants and glidants also can serve as anti-agglomeration agents during tablet manufacture. Suitable lubricating agents include, but are not limited to, such agents as silica, silicon dioxide, talc, magnesium stearate, stearic acid, calcium stearate, sodium stearyl fumarate, and polyethylene glycol (PEG). Other lubricants are available including triglyceride and monoglyceride in powder form. The most widely used lubricant is magnesium stearate. In one aspect, the lubricant is added to the tablet in an amount of 0.1-5% (w/w), such as 0.2-2% (w/w) or 0.3-1.5% (w/w).

In one aspect, the tablets disclosed herein comprise a glidant. In one aspect, the glidant is fused silica (commercial name is Aerosil) which has been found to facilitate good flow properties of the powder. This is important during the tablet production in order to obtain a constant weight of each tablet. In one aspect, the glidant added to the tablet in an amount of 0.1-5% (w/w), such as 0.2-2% (w/w) or 0.3-1.5% (w/w). In one aspect, other tablet excipients than enzyme powder and disintegrants is a mix of filler (such as for example sorbitol, wheat starch and NaCl), lubricant (such as for example 0.4% Mg-stearate (w/w of tablet)), and glidant (such as for example 0.5% aerosil (w/w of tablet)). In general it is advantageous if the filler is found neutral to tablet performance, meaning that it can be used to standardize the activity of the tablet to a certain level. More filler can be used if the enzyme powder has high activity per gram and less is used if the activity of the enzyme powder is lower. If this change in level of filler only influence disintegration and friability to a small degree it is easy to handle in the commercial production.

Other optional excipients such as perfumes, scents and colorants may be added to the tablets. For instance, colorants may be dyes such as red lake #40 or blue lake #1, that are mixed in with the tablet excipients prior to tableting, generally in an amount at less than 0.01% (w/w). The tablets disclosed herein may be color-coded for the convenience of the user, and for those embodiments that contain more than one type of enzyme tablet, the packaging material can include a key matching the color to the specific purpose of each tablet.

Adjunct excipients may be added to the tablets of the present invention, including but not limited to: metallic salts, antioxidants, enzyme protecting agents/scavengers such as ammonium sulfate, ammonium citrate, urea, guanidine hydrochloride, guanidine carbonate, guanidine sulfonate, thiourea dioxide, monethyanolamine, diethanolamine, triethanolamine, amino acids such as glycine, sodium glutamate and the like, proteins such as bovine serum albumin, casein and the like.

### FURTHER EMBODIMENTS OF THE INVENTION

### Embodiment 1

A method for the preparation of an enzyme tablet, the method comprising the following steps:
a) mixing of an enzyme and an insoluble carrier to obtain a slurry,
b) drying of said slurry to obtain a dried enzyme powder with particles having a volume mean diameter greater than 30 μm, and wherein the content of insoluble carrier in the dried enzyme powder is at least 10% (w/w) and at the most 50% (w/w) based on the weight of the dried enzyme powder, and
c) direct compression of said dried enzyme powder to a tablet, wherein said tablet comprises at least 10% (w/w) of said enzyme.

### Embodiment 2

The method according to embodiment 1, wherein the content of insoluble carrier in the dried enzyme powder is at least 10% (w/w) and at the most 50% (w/w) based on the weight of the dried enzyme powder, such as at least 10% (w/w) and at the most 40% (w/w) based on the weight of the dried enzyme powder, such as at least 10% (w/w) and at the most 30% (w/w) based on the weight of the dried enzyme powder, or such as at least 10% (w/w) and at the most 20% (w/w) based on the weight of the dried enzyme powder.

### Embodiment 3

The method according to any one of embodiments 1-2, wherein said enzyme is added to obtain the slurry in the form of an enzyme solution.

### Embodiment 4

The method according to embodiment 3, wherein said enzyme solution has an enzyme purity in the interval of 50-100% (w/w) pure enzyme, such as in the interval of 60-100% (w/w) pure enzyme, such as in the interval of 65-100% (w/w) pure enzyme, such as in the interval of 70-100% (w/w) pure enzyme, such as in the interval of 75-100% (w/w) pure enzyme.

### Embodiment 5

The method according to embodiment 3, wherein said enzyme solution has an enzyme purity in the interval of 50-95% (w/w) pure enzyme, such as in the interval of 60-95% (w/w) pure enzyme, such as in the interval of 65-95% (w/w) pure enzyme, such as in the interval of 70-95% (w/w) pure enzyme, such as in the interval of 75-95% (w/w) pure enzyme.

### Embodiment 6

The method according to embodiment 3, wherein said enzyme solution has an enzyme purity in the interval of 50-90% (w/w) pure enzyme, such as in the interval of 60-90% (w/w) pure enzyme, such as in the interval of 65-90% (w/w) pure enzyme, such as in the interval of 70-90% (w/w) pure enzyme, such as in the interval of 75-90% (w/w) pure enzyme.

### Embodiment 7

The method according to any one of embodiments 1-6, wherein said enzyme solution has a dry matter content of 4-20% (w/w), such as 5-20% w/w, such as 5-15% (w/w) or 6-12% (w/w).

### Embodiment 8

The method according to any one of embodiments 1-7, wherein said enzyme solution has a pH of 4-8, such as a pH from 5-7 or such as a pH of 5.5-6.5.

### Embodiment 9

The method according to any one of embodiments 1-8, wherein said enzyme is one or more selected from the group consisting of an amylase, a protease, a xylanase, an oxidase, and a lipase.

### Embodiment 10

The method according to any one of embodiments 1-9, wherein said enzyme is dissolved in a food and/or feed approved solvent such as water.

### Embodiment 11

The method according to any one of embodiments 1-10, wherein said tablet comprises between 10% (w/w) and 45% (w/w) enzyme, such as between 10% (w/w) and 40% (w/w) enzyme, such as between 15% (w/w) and 20% (w/w) enzyme.

### Embodiment 12

The method according to any one of embodiments 1-11, wherein the insoluble carrier is selected from the group consisting of polyvinylpolypyrrolidone (PVPP), microcrystalline cellulose, and wheat starch, such as selected from the group consisting of microcrystalline cellulose, and wheat starch.

### Embodiment 13

The method according to any one of embodiments 1-12, wherein the insoluble carrier is microcrystalline cellulose.

### Embodiment 14

The method according to any one of embodiments 1-13, wherein the insoluble carrier is particulate microcrystalline cellulose optionally coated with silica.

### Embodiment 15

The method according to any one of embodiments 1-14, wherein the insoluble carrier is particulate microcrystalline cellulose.

### Embodiment 16

The method according to any one of embodiments 1-15, wherein the particulate microcrystalline cellulose has a volume mean diameter between 25-150 μm such as between 30-75 μm.

### Embodiment 17

The method according to any one of embodiments 1-16, wherein the ratio of insoluble carrier to total dry matter of the enzyme slurry in step b) is between 10-50% (w/w) such as between 10-40% (w/w), such as between 10-30% (w/w) or such as between 10-20%(w/w).

### Embodiment 18

The method according to any one of embodiments 1-17, wherein said drying is spray drying such as a one stage spray drying.

### Embodiment 19

The method according to any one of embodiments 1-18, wherein said enzyme particles of step b) have a volume mean diameter between 30-250 μm, such as between 30-150 μm, such as between 35-75 μm or between 40-75 μm.

### Embodiment 20

The method according to any one of embodiments 1-19, wherein said enzyme particles of step b) are further agglomerated before direct compression.

### Embodiment 21

The method according to embodiment 20, wherein the agglomeration is by fluid bed or wet granulation.

### Embodiment 22

The method according to embodiment 20, wherein the agglomeration is by fluidized spray drying.

### Embodiment 23

The method according to any one of embodiments 1-22, wherein said agglomerated enzyme particles have a volume mean diameter between 40-250 μm, such as between 50-150 μm.

### Embodiment 24

The method according to any one of embodiments 1-23, wherein the dried enzyme particles or dried agglomerated enzyme particles are mixed with further tablet excipients before step c).

### Embodiment 25

The method according to any one of embodiments 1-24, wherein said tablet excipients are one or more selected from the group of binders, fillers, diluents, glidants, lubricants and disintegrants.

### Embodiment 26

The method according to any one of embodiments 1-25, wherein one or more of the tablet excipients are a disintegrant.

### Embodiment 27

The method according to embodiment 26, wherein the disintegrant is the same as the insoluble carrier in step a).

### Embodiment 28

The method according to any one of embodiments 1-27, wherein said disintegrant is particulate microcrystalline cellulose optionally coated with silica.

### Embodiment 29

The method according to any one of embodiments 1-28, wherein the amount of disintegrant added as an tablet excipient is between 20-80% w/w, such as between 30-65% w/w, such as between 40-56% (w/w) or between 50-60% (w/w).

### Embodiment 30

The method according to any one of embodiments 1-29, wherein the tablet self-disintegrates within 300 seconds, such as within 180 seconds.

### Embodiment 31

The method according to any one of embodiments 1-30, wherein the tablet disintegrates within 180 seconds, such as within 100 seconds.

### Embodiment 32

An enzyme tablet obtained or obtainable by the method according to any one of embodiments 1-31.

### Embodiment 33

Use of an enzyme tablet according to embodiment 32 in a food, feed or baking application.

### General Procedures

### G4 Amylase Activity Test

One Betamyl Kilo unit (BMK) refers to an internal standard enzyme of G4 amylase with a defined activity.

The substrate for the G4 amylase is Blocked p-Nitrophenyl-a-D-Maltoheptoside (BPNPG7). After the action of the G4 amylase the substrate is further degraded by glucoamylase and alpha-glucosidase to PNP that is measured spectrophotometrically at 410 nm.

The reaction is carried out at pH=5.6 for 5 min at 30° C.

The substrate BPNPG7 can be sourced from “Megazyme.com” with the commercial name Ceralpha® substrate.

### FNA Proteolytic Activity Test

The assay is calibrated against an assigned standard. The assay is colorimetric and monitors the rate of degradation of N-succinyl-ala-ala-pro-phe-p-nitroanalide substrate. The release of the substrate's p-nitroanalide is measured at 405 nm using a Konelab analyzer. The assay is calibrated against an assigned standard.

Using this standard the unit of the assay is mg FNA per g of sample. It means that the purity of a liquid samples can be calculated, if also the dry matter content of the sample is known.

### Friability Test

The friability test as used herein is a measure for the stability of the tablet and is expressed in weight % of the tablet that is broken off by rotating the tablets in a drum for 4 minutes with 25 RPM. This test should resemble a test of having the tablets to fall 13.9 cm for 100 times.

The principles of the test follow the USP pharmacopoeia (USP 35, General Information/(1216) Tablet Friability 867-868, December 2012) and the test uses for example a Vankel friabilator.

### Disintegration Test

The disintegration test (also called solubility test) as used herein is a measure for the ability of the tablet to disintegrate in water and pass through a screen. The principles of the test follows the USP pharmacopoeia (USP 35, Physical tests/(701) Disintegration 293-295, December 2012). The test is carried out for example using a VanKel, VK 100 Programmable Disintegration Tester. The principle is a wire basket moving up and down in a water bath. The time is counted as steps of 30 seconds, until the tablet disappears.

### Self-Disintegration Test

### Principle

Three tablets are placed in a beaker with 100 ml of lukewarm water (15±5° C.). After 180 s with no agitation or movement it is checked whether the tablets have self-disintegrated. This is checked by gently pouring the slurry through a tea sieve (=tea strainer) (pore size 0.5-1 mm). Additional 75-100 ml water is poured gently over the sieve to make a quick cleaning by removing foam and smaller particles. No tablet fragments must be retained on the sieve.

### Purity of an Enzyme Solution or Enzyme Slurry

The purity of the enzyme solution is defined as the dry matter content of the enzyme in the solution or in the slurry (W_dry enzyme) divided by the dry matter content of the solution (W_dry solution). Hence it can be written as purity %=W_dry_enzyme/W_dry_solution.

### Dry Matter Determination Test

The dry matter content of an enzyme solution or an enzyme powder sample is determined according to a test, which uses the principles of an oven dried sampled that is weighed before and after 4 hours incubation at 105° C.

The result is reported in percentage.

### Loose Powder Density Determination

Weigh an empty cylinder glass (w_before), which is produced to be accurate 100 ml

Fill gently up to the rim with powder using a spoon and a wide funnel. Avoid shaking or tapping the glass.

Remove the top and scrape off powder until it is flush with the rim of the glass cylinder. Care should be taken not to compress or vibrate the glass. Brush off excess powder from the outside edge of the cylinder.

Weigh the full cylinder (W_after)

Loose powder density is now calculated as (W_after−W_before)/100 (g/cm³)

### Specific Activity of G4 Amylase

Determination of specific activity (see also definition above) can be done by purifying the protein, showing that it is pure and performing a total protein determination (typical nitrogen determination like Kjeldal determination). Purification and total protein determination may be carried out by two or more different methods that should give consistent results. Knowing the sequence of the enzyme the nitrogen content can be converted to enzyme protein (Amylase G4 as used in the examples has a conversion of 5.61 g protein/g nitrogen). The activity is measured (for instance G4 amylase as used in the examples uses the G4 amylase activity test in the section “General Procedures”) and the specific activity can be calculated and reported as U/mg. The specific activity of G4 amylase as used in the examples was determined to be 3.0 BMK/mg enzyme.

### Specific Activity of FNA Protease

Determination of specific activity of FNA protease may be measured following the same principle as above or may be obtained from the producer of the protease.

### Materials

The term “Other mix” is used herein in relation to tableting to describe the part of the powder blend for tableting that does not consist of MCC and enzyme.

The “Other mix” is glidant, lubricant and the filler.

First step is to calculate the lubricant and glidant based on the total weight of the tablet.

Lubricant: 0.4% Mg-stearate (w/w of tablet),

Glidant: 0.5% aerosil (w/w of tablet)

Second step is to calculate the excipient of the remainder of the “Other mix”.

The ratios between the three excipients are the same in all of the following examples:

Sorbitol: 10% (w/w of “Other mix”)
Wheat starch: 75% (w/w “Other mix”)
NaCl: 15% (w/w “Other mix”)

For example, if the “Other mix” is 10% and the total weight of the tablet mix is 1 kg, then the composition of the “Other mix” can be calculated:

“Other mix” is 10% of 1 kg=100 g

### Mg-stearate: 4 g

### Aerosil: 5 g

The remainder is 100−4−5=91 g

### Sorbitol: 9.1 g

Wheat starch: 68.25 g

### NaCl: 13.65 g

The term “G4 amylase ferment” as used in the following examples is a ferment of an amylase having SEQ ID No: 1, and which may be produced by fermentation of Bacillus subtilis for example as described in WO2010/133644.

The term FNA protease enzyme ferment as used in example 13 is a ferment of a protease having SEQ ID No: 2, also described in U.S. Pat. No. 4,760,025. It may be produced by fermentation of Bacillus subtilis for example as described in WO2010/133644.

A larger amount of ferment of G4 or FNA may also be produced by using a larger fermentor; typically a fermentor size at 10 m³ or larger would be used if more than 1000 kg of enzyme solution is needed.

The substrate can be similar to described in WO2010/133644 or it can be optimized for lower cost by substitution of yeast extract with soy flour or meal and various salts like ferrous sulphate, manganese sulphate and magnesium sulfate. The fermentor should be equipped with airflow (for example 1 VVM=volume air per volume fermentor per minutes) and agitation to keep dissolved oxygen at 20% of air saturation or higher and maintained adequate mixing. A batch process may be applied where the carbon source dextrose is added before inoculation of the fermentor or more preferred a carbon-limited fed-batch process may be used were sugar is added continuously.

Temperature is controlled at 37° C., but may also be optimized in the range from 33-40° C., and pH at 6.8 (or between 6.3 and 7.3) by the use of a 28% (w/v) ammonium hydroxide solution. Biomass concentration can be followed by optical density measurements at 660 nm and G4 amylase production is followed by using the G4 amylase activity test.

### EXAMPLES

### Example 1

This example shows preparation of an enzyme solution.

Cells are separated from a G4 amylase enzyme ferment of Bacillus subtilis by the use of a rotary vacuum filter or similar, and the cell free fermentation broth is concentrated on a cross-flow ultrafiltration equipment with 10 KDal membrane to produce a more concentrated solution of G4 amylase. The enzyme concentrate (called UFC1) is then adjusted with acetic acid to pH=4.6 and the enzyme is precipitated to form a slurry. On a centrifuge the precipitate is separated from the supernatant. The supernatant now has a concentration of less than 2% of the concentration of G4 amylase in UFC1, but the supernatant still contains other soluble material carried over from the fermentation.

The enzyme precipitate containing slurry is adjusted to pH=6 to bring G4 amylase into solution again. 0.1% potassium sorbate is added as microbial protection and carbon is added to remove color. The solution is then filtered to remove carbon and lower the microbial count. This enzyme solution now has a higher purity than UFC1, because none enzyme soluble material was removed with the supernatant. This product is now placed in 1000 kg totes (or a tank) and is called the “enzyme solution” in the following examples.

### Example 2

This example shows drying of an enzyme solution with an insoluble carrier to produce a powder.

1000 kg of G4 amylase in the form of an enzyme solution prepared as described in example 1 with a dry matter content of 5.6% (w/w) and an enzyme activity of 148 BMK/g (purity=148 (BMK/g solution)/3 (BMK/mg G4)/56 (g dry matter/1000 g solution=88.1%) and a pH of 6 was added to a tank with agitation. 35 kg of MCC (Avicel PH 101) was added. The tank was constantly agitated to keep it as a homogenous suspension. The suspension was then feed to a spray drier with an atomizing wheel forming the droplets. The spray dryer was adjusted to give the maximum droplet size that could still result in a dry powder with a high enzyme recovery. Liquid feeding rate was adjusted to 350 kg/hours, the wheel speed to 7000 RPM and the heat input was adjusted to give an air inlet to the spray drier of 200° C. and air outlet of 78° C. The dried powder had a dry matter content of 96.3% (measured using the dry matter test found in the “General Procedures” section). Powder was collected with an activity of 1240 BMK/g. Particle size of the powder D [4,3] was 52.7 μm. Based on the dry matter content in the enzyme solution and the amount of added MCC the carrier content in the powder in percentage can be calculated to ((35/(35+1000*0.056))×0.963)=37%

Based on above numbers and a dry weight balance the theoretical activity of the powder (if there was no enzyme loss) is 1578 BMK/g or the recovery is 1240/1578=79%.

### Example 3

1000 kg of G4 amylase in the form of an enzyme solution prepared as described in example 1 with a dry matter content of 5.6% (w/w) and an enzyme activity of 148 BMK/g (purity=88.1%) was added to a tank with agitation. 17 kg of MCC (Avicel PH 101) is added.

The slurry is then spray dried as described in example 2.

The dry matter of the powder is 95.7%. Particle size D[4,3] is 38.3 μm. Activity is 1750 BMK/g. Carrier content (MCC content) in the powder is 22%.

### Example 4

1000 kg of G4 amylase in the form of an enzyme solution prepared as described in example 1 with a dry matter content of 5.6% (w/w) and an enzyme activity of 148 BMK/g (purity=88.1%) is added to a tank with agitation. 37 kg of MCC (Avicel PH 101)+17 kg NaCl was added. The slurry is then spray dried as explained in example 2.

The dry matter of the powder is 95.7%. Particle size D[4,3] is 40 μm. Activity is 1350 BMK/g. Carrier content (MCC content) in the powder is 38%.

### Example 5

This example shows that use of even a high amount of soluble carrier is not increasing the particle size nearly as effective as with the insoluble MCC carrier.

1000 kg of G4 amylase in the form of an enzyme solution prepared as described in example 1 with a dry matter content of 5.6% (w/w) and an enzyme activity of 148 BMK/g (purity-88.1%) is added to a tank with agitation. 60 kg of NaCl and 125 kg of maltodextrin was added. Agitation is continued for 30 min to bring NaCl and Maltodextrin into solution. The solution is then pumped to a spray drier and dried as described in example 2.

The dry matter of the powder is 96.4%. Particle size (Ps) D[4,3] is 26.5 μm. Activity is 472 BMK/g

Below table 1 shows that it is the insoluble carrier that helps increasing particle size. Even high amount of soluble carrier does not help on particle size.

TABLE 1

| | | | Insoluble | Soluble | |
|---|---|---|---|---|---|
| Example | Ps D[4,3] | Activity | carrier | carrier | |
| No | (μm) | (BMK/g) | (kg) | (kg) | Carrier |
| 2 | 52.7 | 1240 | 35 | 0 | Avicel 35 kg |
| 3 | 38.3 | 1750 | 17 | 0 | Avicel 17 kg |
| 4 | 40.0 | 1350 | 17 | 17 | Avicel 17 kg + |
| | | | | | NaCl 17 kg |
| 5 | 26.5 | 472 | 0 | 185 | NaCl 60 kg + |
| | | | | | maltodextrin |
| | | | | | 125 kg |

### Example 6

The table 2 below shows how powders number 1, 2 and 3 are agglomerated into the respective powder numbers 1G, 2G and 3G. This is done in a fluid bed where the powder is slightly wetted with water. For instance Powder No 1 has a particle size D[4,3] of 53.2 μm before agglomeration and after agglomeration the particle size D[4,3] of the powder now called 1G is 81.6 μm. Powders 1, 2 and 3 are produced using a similar process as described in example 3.

TABLE 2

| Powder | | |
|---|---|---|
| Number | Short name | particle size D[4,3] μm |
| 1 | G4 powder spray dried | 53.2 |
| 2 | G4 powder spray dried | 52.1 |
| 3 | G4 powder spray dried | 54.6 |
| 1G | G4 powder agglomerated | 81.6 |
| 2G | G4 powder agglomerated | 82.2 |
| 3G | G4 powder agglomerated | 88.3 |

### Example 7

This example shows how the spray dried powder may be used to produce tablets

The below excipients are mixed in a Nauta mixer for 45 minutes.

420 kg Avicel PH 101 (microcrystalline cellulose), 140 kg Prosolv SMCC 50 (silicified microcrystalline cellulose), 150 kg of powder from example 2 and 150 kg of powder from example 3, 120 kg Neosorb P 60 W (sorbitol) 5 kg of aerosil 200 (fumed silica)

After mixing 45 minutes, 3.5 kg Mg Stearat is added and mixed for 5 min.

The blend is emptied into a big bag. The big bag is transported to the top of the tablet machine Kilian E 150 (blend is close to tablet machine to avoid segregation of the powder)

The tablet machine is adjusted to deliver a constant volume of powder to give a constant weight tablet of 3 g. The height of the tablet is adjusted until the necessary strength is obtained. A lower (more compressed) tablet is stronger. The strength can then be measured by friability test and disintegration test as explained in section “General Procedures”.

### Example 8

This example shows how a powder may be produced by drying an enzyme but without a carrier. The tablet produced from this powder contains 13.7% (w/w) G4 amylase, but the tablet does not disintegrate and hence is not useful in application.

1000 kg of G4 amylase with a dry matter content of 5.6% (w/w) and an enzyme activity of 148 BMK/g (purity=88.1%) is added to a tank with agitation. No carrier or any other substances is added. The enzyme solution is then pumped to a spray drier and dried as explained in example 2.

The activity of the powder was 2050 BMK/g. The powder was made into tablets as described in Example 7. A 5 kg powder blend was produced consisting of 56% MCC (2.8 kg), 20% G4 amylase powder (1 kg), 24% other mix (1.2 kg “Other mix” is defined in the section “Materials”). The enzyme activity of the tablet was then 410 BMK/g equal to 13.7%(w/w) G4 amylase. The tablet could not be produced according to the specification; friability (as described in the “General Procedures” section) is max 5% and disintegration time (as described in the “General Procedures” section) max 180 s. A tablet compressed to a height of 5.2 mm resulted in a Friability of 2.3%, which is within specification, however, the disintegration was >600 s or much higher than 180 s. An attempt to make the tablet looser to decrease disintegration time resulted in a tablet with a height of 6 mm a friability of 6.3%, which is now outside specification of 5%. The tablet still did not disintegrate within 600 s.

TABLE 3

| Disintegration (s) | Friability (%) | Tablet height (mm) | Strength |
|---|---|---|---|
| >600 | 2.3 | 5.2 | 14.5 |
| >600 | 6.3 | 6 | 8.3 |

### Example 9

This example shows a successful production of tablets with 12.4% enzyme protein.

The powder produced in example 2 was compressed into tablet like in example 7. The activity of the powder (example 2) was 1240 BMK/g. 5 kg powder was mixed. 56% MCC (2.8 kg), 30% G4 amylase (1 kg), 14% other mix (“Other mix” is defined in the section “Materials”) (1.2 kg). The enzyme activity of the tablet was then 372 BMK/g equal to 12.4% (w/w) G4 amylase. The table below shows that there are some flexibility in producing the tablet, since two different compressions (different height of the tablets) resulted.

TABLE 4

| Disintegration | | | |
|---|---|---|---|
| time (s) | Friability (%) | Tablet height (mm) | Strength |
| 240 | 1.80% | 6 | 13.8 |
| 150 | 2.90 | 7.2 | 14.1 |

### Example 10

This example shows a successful production of tablets with 16% enzyme protein.

The powder produced from example 3 was compressed into a tablet like in example 7. The activity of the powder was 1600 BMK/g. 5 kg powder was mixed. 56% MCC (2.8 kg), 30% G4 amylase (1 kg), 14% other mix (“Other mix” is defined in the section “Materials”) (1.2 kg). The enzyme activity of the powder mix was then 480 BMK/g equal to 16% (w/w) G4 amylase. The tablet was produced. The table below shows analytical data on disintegration time and friability.

TABLE 5

| Disintegration (s) | Friability (%) | Tablet height (mm) | Strength |
|---|---|---|---|
| 120 | 1.91% | 6 | 13.8 |

### Example 11

The example shows two tablets produced with G4 amylase powder with an activity of 1860 BMK/g and G4 amylase agglomerated like in example 6 with an activity of 1615 BMK/g.

Both tablet A and tablet B contains 15.2% (w/w) of G4 amylase protein; measured as 456 BMK/g. The tablet uses same type of excipients as explained in example 7, but some of the G4 powder has been substituted with G4 powder agglomerated as explained in example 6 and some of the MCC has been substituted with silicified MCC in the form of Prosolv SMCC 50.

Tablet A has a composition (see table 7) where 25% of the MCC has been substituted with SMCC and 50% of the G4 powder has been substituted with G4 powder agglomerated. This creates a tablet with a relatively low disintegration time and a good robustness measured as the ability to produce a tablet at different height without affecting disintegration time and friability percentage too much. It is important for production to have a tablet that can be approved over a certain range of height as to have flexibility in production. If the range is to narrow it is likely that batch to batch variations create tablets which falls outside of the specification.

Tablet A can still be improved; especially with respect to friability which is in the higher end of the acceptable range.

Tablet B increases the SMCC level to 50% of the total amount of SMCC and increase the G4 powder agglomerated to 100% meaning that no G4 powder was used. Tablet B has the same G4 amylase protein content 15.2% (w/w) as tablet A.

The result is now a tablet with even lower disintegration time and lower friability also over a wide range of tablet heights.

TABLE 6

| | Disintegration (s) | Friability (%) | Tablet height (mm) |
|---|---|---|---|
| Tablet A | 90 | 1.52 | 6 |
| | 90 | 2.2 | 6.4 |
| | 90 | 3.27 | 6.8 |
| Tablet B | 90 | 0.39 | 6.2 |
| | 60 | 0.96 | 6.6 |
| | 60 | 1.56 | 7 |

TABLE 7
The table shows the composition in % (w/w) for tablet A and tablet B.

| | | Prosolv | G4 | | | | |
|---|---|---|---|---|---|---|---|
| | | SMCC | Pow- | G4 Powder | sor- | | other |
| | Avicel | 50 | der | Agglomerated | bitol | NaCl | mix |
| Tablet | 42 | 14 | 12.3 | 14.1 | 6.6 | 5 | 6 |
| A | | | | | | | |
| Tablet | 28 | 28 | 0 | 28.2 | 4.8 | 5 | 6 |
| B | | | | | | | |

### Example 12

This example shows how the use of the insoluble carrier during drying increases the density of the powder and hence a higher weight tablet can be produced.

Powder A was produced by using 1000 kg of G4 amylase with a dry matter content of 5.6%(w/w) and an enzyme activity of 148 BMK/g (purity=88.1%). It was added to a tank with agitation. No carrier or any other substances was added. The enzyme solution was then pumped to a spray drier and dried as explained in example 2.

Powder B was produced by using 1000 kg of G4 amylase with a dry matter content of 5.6%(w/w) and an enzyme activity of 148 BMK/g (purity=88.1%). It was added to a tank with agitation. 17 kg of MCC (Avicel PH 101) was added. The slurry was then spray dried as explained in example 2.

### Mix A

A 5 kg powder blend was produced consisting of 56% MCC (2.8 kg), 25% Powder A (1 kg), 19% other mix (1.2 kg) “Other mix” is defined in the section “Materials” The loose powder density measured as described above under “General Procedures” of the tablet mix before producing tablet was 0.336 g/cm³.

### Mix B

A 5 kg powder blend was produced consisting of 56% MCC (2.8 kg), 25% Powder A (1 kg), 19% other mix (1.2 kg) “Other mix” is defined in the section “Materials” The loose powder density of the tablet mix before producing tablet was 0.403 g/cm³.

Using mix B, where the powder was spray dried with the MCC carrier, to produce tablet on a Kilian E tablet machine resulted in tablets that were 23% heavier than producing tablets using mix A, where the powder was spray dried without the use of carrier. For a specific settings of the Killian machine the tablet had a weight of 2.78 g from mix A and a weight of 3.43 g from mix B.

### Example 13

This example shows that drying of an enzyme solution with an isoluble carrier (MCC) gives a powder that can be compressed to a high pay load tablet (>10% (w/w) enzyme protein). This tablet can easily self-disintegrate in water. The example also shows that drying without a MCC carrier results in a tablet, which cannot easily disintegrate in water.

The enzyme solution is prepared in a process almost similar to example 1,

Cells are separated from a FNA protease enzyme ferment of Bacillus subtilis by the use of a rotary vacuum filter or similar, and the cell free fermentation broth is concentrated on a cross-flow ultrafiltration equipment with 10 KDal membrane to produce a more concentrated solution of FNA protease. The enzyme concentrate is added 5% sodium formate/formic acid to pH=5.5 and the FNA enzyme undergoes a crystallization process at 15° C. In 24-48 hours. On a centrifuge the crystals are separated from the supernatant. To obtain higher purity the crystals are washed one time with cold water.

The crystals are resolubilised by using 1 part by weight of crystals and 3 part of water at 45° C. followed by agitation for 30 min. This solution is now referred to as the FNA enzyme solution.

Powder N1 with MCC

4.68 kg of an FNA enzyme solution with a dry matter content of 8.2% and a purity, as defined in the section “General Procedures”, of 93% is added to a tank with agitation together with 0.094 kg of the insoluble MCC carrier Vivapur 101. The enzyme slurry was spray dried on a Niro Spray Dryer size 6.3. The dried powder, here called N1, was analysed to have a FNA protease content of 585 mg/g (=58.5% (w/w)) and DM=93.5% The calculated insoluble carrier content is (0.094/(0.082×4.68+0.094)×0.935=18.4%

Powder L2 without MCC

4.6 kg of an FNA enzyme solution with a dry matter content of 7.5% and a purity of 82% is spray dried in a process similar to N1, but without the use of a carrier. The dried powder here called L2 was analysed to have a FNA protease content of 611 mg/g (=61.1% (w/w)) and DM=95%.

The powders N1 and L2 had the following particles sizes as shown in table 8 below:

TABLE 8

| Powder ID | Enzyme % (w/w) | Particle size D[4,3] |
|---|---|---|
| N1 | 58.5 | 41.1 μm |
| L2 | 61.1 | 25.4 μm |

Powder blends was made from the two powder enzyme N1 and L2 as shown below in table 9.

TABLE 9
The table shows the composition of powder blends used
to make tablets from N1 powder and L2 powder.

| | | Vivapur | Native Wheat | Fumed Silica |
|---|---|---|---|---|
| | Enzyme | 101 | starch {from | {CAB-O-SIL |
| | % | % | Amilina} % | EH-5} % |
| Blend ID | (w/w) | (w/w) | (w/w) | (w/w) |
| Blend with N1 | 22 | 60 | 17.5 | 0.5 |
| Tablet L2 | 20 | 60 | 19.5 | 0.5 |

The powder blends was compressed into tablets using a manual single punch tablet press with pressure control. The pressure was adjusted to reach a level of tablet friability just below 5%, which will produce the tablets that are easiest to disintegrate.

Table 10 shows data for the tablets produced. The tablet with powder N1 contains 12.5% enzyme and disintegrate easily (160 s), whereas the tablets with powder L2 takes much more than 6 min to disintegrate (>>360 s).

TABLE 10
the table shows how the tablet produced from N1; the powder with an MCC
carrier results in a good quality tablet that can disintegrate, whereas the
tablet produced from the powder L2 without the use of carrier results
in a tablet that cannot disintegrate within a reasonable timeframe.

| | Weight | | Fria- | Self- | FNA |
|---|---|---|---|---|---|
| | g per | Tablet | bility | disintegration | Enzyme % |
| Tablet ID | tablet | dimensions | % | (s) | (w/w) |
| Tablet | 5 | | 3.47 | 160 | 12.5 |
| with N1 | | | | | |
| Tablet | 5 | | 3.56 | >>360 | 13.3 |
| with L2 | | | | | |

SEQUENCE LISTING

SEQ ID NO: 1. MATURE PROTEIN SEQUENCE OF PMS382
DQAGKSPAGVRYHGGDEIILQGFHWNVVREAPYNWYNILRQQASTIAAD
GFSAIWMPVPWRDFSSWTDGDKSGGGEGYFWHDFNKNGRYGSDAQLRQA
AGALGGAGVKVLYDVVPNHMNRFYPDKEINLPAGQRFWRNDCPDPGNGP
NDCDDGDRFLGGEADLNTGHPQIYGMFRDEFTNLRSGYGAGGFRFDFVR
GYAPERVDSWMSDSADSSFCVGELWKEPSEYPPWDWRNTASWQQIIKDW
SDRAKCPVFDFALKERMQNGSVADWKHGLNGNPDPRWREVAVTFVDNHD
TGYSPGQNGGQHKWPLQDGLIRQAYAYILTSPGTPVVYWPHMYDWGYGD
FIRQLIQVRRTAGVRADSAISFHSGYSGLVATVSGSQQTLVVALNSDLA
NPGQVASGSFSEAVNASNGQVRVWRSGSGDGGGNDGG
SEQ ID NO: 2. MATURE PROTEIN SEQUENCE OF FNA
AQSVPYGVSQIKAPALHSQGYTGSNVKVAVIDSGIDSSHPDLKVAGGAS
MVPSETNPFQDNNSHGTHVAGTVAALNNSIGVLGVAPSASLYAVKVLGA
DGSGQYSWIINGIEWAIANNMDVINMSLGGPSGSAALKAAVDKAVASGV
VVVAAAGNEGTSGSSSTVGYPGKYPSVIAVGAVDSSNQRASFSSVGPEL
DVMAPGVSIQSTLPGNKYGALNGTSMASPHVAGAAALILSKHPNWTNTQ
VRSSLENTTTKLGDSFYYGKGLINVQAAAQ

1. A method for the preparation of an enzyme tablet, the method comprising the following steps:
a) mixing of an enzyme and an insoluble carrier to obtain a slurry,
b) drying of said slurry to obtain a dried enzyme powder with particles having a volume mean diameter greater than 30 μm, and wherein the content of insoluble carrier in the dried enzyme powder is at least 10% (w/w) and at the most 50% (w/w) based on the weight of the dried enzyme powder, and
c) direct compression of said dried enzyme powder to a tablet, wherein said tablet comprises at least 10% (w/w) of said enzyme.

2. The method according to claim 1, wherein said enzyme is added to obtain the slurry in the form of an enzyme solution.

3. The method according to claim 2, wherein said enzyme solution has an enzyme purity in the interval of 50-90% (w/w) pure enzyme, such as in the interval of 60-90% (w/w) pure enzyme, such as in the interval of 65-90% (w/w) pure enzyme, such as in the interval of 70-90% (w/w) pure enzyme, such as in the interval of 75-90% (w/w) pure enzyme.

4. The method according to claim 2, wherein said enzyme solution has a dry matter content of 4-20% (w/w), 5-20% w/w, such as 5-15% (w/w) or 6-12% (w/w).

5. The method according to claim 1, wherein said enzyme is one or more selected from the group consisting of an amylase, a protease, a xylanase, an oxidase, and a lipase.

6. The method according to claim 1, wherein said tablet comprises between 10% (w/w) and 45% (w/w) enzyme, such as between 10% (w/w) and 40% (w/w) enzyme, such as between 15% (w/w) and 20% (w/w) enzyme.

7. The method according to claim 1, wherein the insoluble carrier is selected from the group consisting of polyvinylpolypyrrolidone (PVPP), microcrystalline cellulose, and wheat starch, preferably microcrystalline cellulose.

8. The method according to claim 1, wherein the insoluble carrier is particulate microcrystalline cellulose such as optionally coated with silica.

9. The method according to claim 1, wherein the particulate microcrystalline cellulose has a volume mean diameter between 25-150 μm such as between 30-75 μm.

10. The method according to claim 1, wherein the content of insoluble carrier in the dried enzyme powder is at least 10% (w/w) and at the most 40% (w/w) based on the weight of the dried enzyme powder, such as between 10-35% (w/w) or between 10-30% (w/w), or between 10-20% (w/w).

11. The method according to claim 1, wherein said drying is spray drying such as a one stage spray drying.

12. The method according to claim 1, wherein said enzyme particles of step b) have a volume mean diameter between 30-250 μm, such as between 30-150 μm, such as between 35-75 μm or such as between 40-75 μm.

13. The method according to claim 1, wherein said enzyme particles of step b) are further agglomerated such as by such as fluidized spray drying before direct compression.

14. The method according to claim 13, wherein said agglomerated enzyme particles have a volume mean diameter between 40-250 μm, such as between 50-150 μm.

15. The method according to claim 1, wherein the dried enzyme particles or dried agglomerated enzyme particles are mixed with further tablet excipients before step c) such as a disintegrant.

16. The method according claim 15, wherein the amount of disintegrant added as an tablet excipient is between 20-80% w/w, such as between 30-65% w/w, such as between 40-56% (w/w) or between 50-60% (w/w).

17. The method according to claim 1, wherein the tablet self-disintegrates within 300 seconds, such as within 180 seconds and/or wherein the tablet disintegrates within 180 seconds, such as within 100 seconds.


SEQUENCE LISTING (2 sequences)

SEQ ID NO: 1 - protein, 429 aa, Artificial Sequence
  MATURE PROTEIN SEQUENCE OF PMS382
DQAGKSPAGVRYHGGDEIILQGFHWNVVREAPYNWYNILRQQASTIAADGFSAIWMPVPWRDFSSWTDGDKSGGGEGYFWHDFNKNGRYGSDAQLRQAAGALGGAGVKVLYDVVPNHMNRFYPDKEINLPAGQRFWRNDCPDPGNGPNDCDDGDRFLGGEADLNTGHPQIYGMFRDEFTNLRSGYGAGGFRFDFVRGYAPERVDSWMSDSADSSFCVGELWKEPSEYPPWDWRNTASWQQIIKDWSDRAKCPVFDFALKERMQNGSVADWKHGLNGNPDPRWREVAVTFVDNHDTGYSPGQNGGQHKWPLQDGLIRQAYAYILTSPGTPVVYWPHMYDWGYGDFIRQLIQVRRTAGVRADSAISFHSGYSGLVATVSGSQQTLVVALNSDLANPGQVASGSFSEAVNASNGQVRVWRSGSGDGGGNDGG

SEQ ID NO: 2 - protein, 275 aa, Artificial Sequence
  MATURE PROTEIN SEQUENCE OF FNA
AQSVPYGVSQIKAPALHSQGYTGSNVKVAVIDSGIDSSHPDLKVAGGASMVPSETNPFQDNNSHGTHVAGTVAALNNSIGVLGVAPSASLYAVKVLGADGSGQYSWIINGIEWAIANNMDVINMSLGGPSGSAALKAAVDKAVASGVVVVAAAGNEGTSGSSSTVGYPGKYPSVIAVGAVDSSNQRASFSSVGPELDVMAPGVSIQSTLPGNKYGALNGTSMASPHVAGAAALILSKHPNWTNTQVRSSLENTTTKLGDSFYYGKGLINVQAAAQ